(19) United States
(12) Patent Application Publication
(10) Pub. No.: US 2024/0138627 A1
(43) Pub. Date: May 2, 2024

(54) ELECTRIC STIRRING CUP

(71) Applicant: Guoxin Wei, Shenzhen (CN)

(72) Inventor: Guoxin Wei, Shenzhen (CN)

(21) Appl. No.: 17/990,153

(22) Filed: Nov. 18, 2022

(30) Foreign Application Priority Data
Nov. 2, 2022 (CN) 202222905649.0

(51) Int. Cl. A47J 43/27; A47G 19/22; A47J 43/046; A47J 43/07; B01F 27/808; B01F 33/501; B01F 35/32; B01F 35/45; H02J 7/00; H02K 11/00

(52) U.S. Cl. CPC A47J 43/27; A47G 19/2272; A47J 43/046; A47J 43/0716; B01F 27/808; B01F 33/50111; B01F 35/32025; B01F 35/3204; B01F 35/45; H02J 7/0042; H02K 11/0094; B01F 2035/351; H02K 2211/03

(57) ABSTRACT

Disclosed is an electric stirring cup, where one end of a hollow cup body is connected with a cup cover through threaded connection; one end of the hollow cup body far from the cup cover is connected with a base; a connecting end is integrally formed on the base; an inner wall of the one end of the hollow cup body far from the cup cover forms a connecting cavity, the connecting cavity is in threaded connection with the connecting end; a stirring mechanism is installed in the base; and a drinking mechanism is installed on the cup cover. A drink that needs to be stirred is poured in, and after being directly stirred and mixed through the stirring mechanism, the drink may be consumed after the cup cover is unscrewed, whereby the electric stirring cup is easy to use. The hollow cup cavity and the stirring mechanism may be directly cleaned after disassembling the base, whereby the electric stirring cup is easy to clean.

### TECHNICAL FIELD

The present invention relates to the technical field of a stirring cup, and in particular to an electric stirring cup.

### BACKGROUND

The stirring cup is composed of a cup cover, a cup body and a base. There is a rotatable plastic sheet like a propeller in the middle of the cup body, which is used to mix or break drinks and objects in the cup body. For example, the stirring cup is used for stirring and mixing for coffee, fruit juice and other applications. However, the current stirring cup has the following problems:
1. A motor links a stirring blade through a transmission structure. Due to the existence of the transmission mechanism, the kinetic energy of the motor is greatly consumed, resulting in insufficient stirring force and serious energy consumption, which will lead to poor product stirring effect and insufficient endurance.
2. The stirring blade of the current stirring cup is generally located in the deep part of the body, which is inconvenient to clean. In view of the above problem, the inventor proposed an electric stirring cup to solve the above problem.

### SUMMARY

In order to solve the problem that the current stirring cup has poor stirring effect and insufficient endurance, and the stirring blade is located in the deep part of the body, which is inconvenient to clean. The present invention aims at providing an electric stirring cup.

In order to solve the above technical problem, the present invention adopts the following technical solution an electric stirring cup, including a hollow cup body, where: one end of the hollow cup body is connected with a cup cover through threaded connection, one end of the hollow cup body far from the cup cover is connected with a base, a connecting end is integrally formed on the base, an inner wall of the one end of the hollow cup body far from the cup cover forms a connecting cavity, the connecting cavity is in threaded connection with the connecting end, an end surface of one end of the connecting end far from the base is integrally formed with a convex block, a circular edge of the convex block is embedded with a sealing gasket; an inner wall of the connecting cavity is installed and fixed with a pressing ring, the pressing ring is tightly pressed on the sealing gasket, a stirring mechanism is installed in the base, and a drinking mechanism is installed on the cup cover.

Preferably, the hollow cup body and the base are of a round table structure with a large upper part and a small lower part, an inner wall of one end of the hollow cup body close to the connecting cavity is provided with a number of flow blocking protrusions, the convex block is of an upward convex spherical structure, the diameter of one end of the convex block close to the sealing gasket is smaller than the inner diameter of the pressing ring, the sealing gasket is of an annular structure, the top of the sealing gasket is integrally formed with a plurality of annular protrusions with semicircular cross section, the bottom of the pressing ring is tightly pressed on the annular protrusions, and the stirring mechanism penetrates the convex block and extends into an inner cavity of the hollow cup body.

Preferably, the drinking mechanism includes a hinged fixed base and a drinking nozzle, one end of the top of the cup cover is fixedly installed with the hinged fixed base, the other end of the top of the cup cover is integrally formed with the drinking nozzle, the hinged fixed base is rotatably installed with a lifting ring and a rotating block through a hinge pin; the lifting ring is capable of being turned upward with respect to the rotating block, an outer wall of the rotating block is fixedly connected with a connecting ring, the connecting ring is internally rotated and clamped with a sealing cover, the sealing cover is connected with the drinking nozzle through threaded connection, the top of the cup cover is integrally formed with a stop surface, an outer wall of the rotating block is installed with a stop block, the stop block is of an elastic plastic hemisphere structure, and the stop surface is of an arc structure.

Preferably, one end of the base far from the hollow cup body is provided with a bottom cover, an edge of the bottom cover is integrally formed with a snap ring, a bottom surface of the base is provided with a snap groove, the snap ring is clamped to the snap groove, and a sealing circle is arranged between the top of the snap ring and an inner wall of the snap groove, a plurality of connecting columns are fixedly installed on the bottom cover, the connecting column and an inner wall of the base are connected through a bolt, a motor is comprised in the stirring mechanism, the motor is arranged inside the base, an output shaft of the motor penetrates the convex block and fixedly clamps a stirring blade, the center of the top of the convex block is fixedly sleeved with a sealing ring, and the output shaft of the motor penetrates the sealing ring.

Preferably, a circuit board is fixedly installed in the base, the motor is fixedly installed on the circuit board, both sides of the base are respectively installed with a switch button and a charging port, the charging port is movably clamped with a silicone plug, the top of the bottom cover is fixedly installed with a storage battery, the motor, the storage battery, the switch button and the charging port are all electrically connected to the circuit board.

Compared with the prior art, the present invention has the following beneficial effects:

The hollow cup body and the base are connected through the connecting cavity and the connecting end. The convex block protrudes from the inner cavity of the pressing ring, and the pressing ring is tightly pressed on the sealing gasket to achieve sealing, so as to avoid the leakage of the drink. During stirring, the stirring blade is located in the hollow cup body, and the drink in the hollow cup body is stirred and mixed by the rotation of the motor. The flow blocking protrusion makes the inner wall of the hollow cup body produce an uneven structure, thereby preventing the eddy current of the drink when the drink is rotated and stirred continuously, so that the mixing is more uniform.

After stirring, the sealing cover is unscrewed, and the connecting ring rotates through the rotating block, so that the drinking nozzle is exposed, which is convenient for drinking directly through the drinking nozzle. Besides, when the rotating block 33 rotates, the stop block 36 moves along the stop surface 38 of the arc structure, and the distance between the stop surface 38 and the rotating block 33 gradually decreases, so as to squeeze the stop block 36 for damping and fixing, and prevent the sealing cover 35 from falling on a user's face during drinking. After mixing, the drink can be drunk by unscrewing the cup cover or by using a drinking mechanism, which is convenient for using. In addition, the inner cavity of the hollow cup body and the stirring mechanism can be directly cleaned after the base is disassembled, which is convenient for cleaning.

The motor of the electric stirring cup is directly connected to the stirring blade, without connecting an intermediate adapter, which reduces energy consumption and has a high power stirring effect.

### BRIEF DESCRIPTION OF THE DRAWINGS

The drawings of the specification that form a part of the present application, are used to provide a further understanding of present the invention. Schematic embodiments and their descriptions of the present invention are used to explain the invention, and do not constitute an improper limitation of the present invention. In the drawings:

FIG. 1 is a structural diagram of the present invention;

FIG. 2 is a schematic diagram of a base structure of the present invention;

FIG. 3 is a structural diagram of a hollow cup body of the present invention;

FIG. 4 is a schematic diagram of an enlarged structure at A in FIG. 1 of the present invention;

FIG. 5 is a schematic diagram of a bottom structure of the cup cover of the present invention;

FIG. 6 is a structure diagram of a stirring mechanism of the present invention;

FIG. 7 is a sectional structure of the present invention;

FIG. 8 is a schematic diagram of an enlarged structure at B in FIG. 7 of the present invention;

FIG. 9 is a schematic diagram of an enlarged structure at C in FIG. 7 of the present invention; and

FIG. 10 is a schematic diagram of an enlarged structure at D in FIG. 7 of the present invention.

### DESCRIPTION OF REFERENCE NUMERALS

1. Hollow cup body; 11. Connecting cavity; 12. Pressing ring; 13. Flow blocking protrusion; 2. Cup cover, 3. Drinking mechanism; 31. Hinged fixed base; 32. Lifting ring; 33. Rotating block; 34. Connecting ring; 35. Sealing cover, 36. Stop block; 37. Drinking nozzle; 38. Stop surface; 4. Base; 41. Connecting end; 42. Convex block; 43. Sealing gasket; 44. Annular protrusion; 5. Stirring mechanism; 51. Motor; 52. Stirring blade; 53. Charging port; 54. Circuit board; 55. Storage battery; 56. Switch button; 57. Silicone plug; 58. Sealing ring; 6. Bottom cover; 61. Snap groove; 62. Snap ring, and 7. Connecting column.

### DETAILED DESCRIPTION OF THE EMBODIMENTS

The present invention will be described in detail below with reference to the drawings and in combination with embodiments. Various examples are provided by way of interpretation of the present invention rather than limiting the present invention. In fact, those skilled in the art will know that modifications and variations can be made in the present invention without departing from the scope or spirit of the present invention. For example, features shown or described as part of one embodiment may be used in another embodiment to generate another embodiment. It is therefore desirable that the present invention includes such modifications and variations that fall within the scope of the appended claims and their equivalents.

In the description of the present invention, the terms “longitudinal”, “latitudinal”, “up”, “down”, “front”, “rear”, “left”, “right”, “vertical”, “horizontal”, “top”, “bottom”, etc. indicate the orientation or positional relationship based on the drawings, which is only for the convenience of describing the present invention rather than requiring the present invention to be constructed and operated in a specific orientation, Therefore, it cannot be understood as a limitation of the present invention. The terms “connected”, “connection” and “configure” used in the present invention should be understood in a broad sense, for example, it can be a fixed connection or a detachable connection; it can be a direct connection or an indirect connection through an intermediate part; it can be a wired electrical connection, a radio connection, or a wireless communication signal connection. For those skilled in the art, the specific meaning of the above terms can be understood according to the specific situation.

One or more examples of the present invention are shown in the drawings. The detailed description uses numerals and letter markers to refer to features in the drawings. Similar or like numerals in the drawings and descriptions have been used to refer to similar or like parts of the present invention. As used herein, the terms “first”, “second”, and “third” are used interchangeably to distinguish one component from another, and are not intended to indicate the location or importance of individual components.

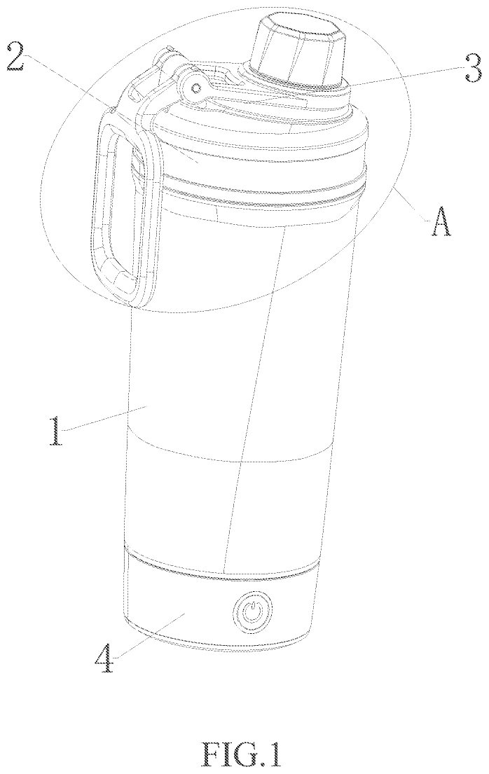

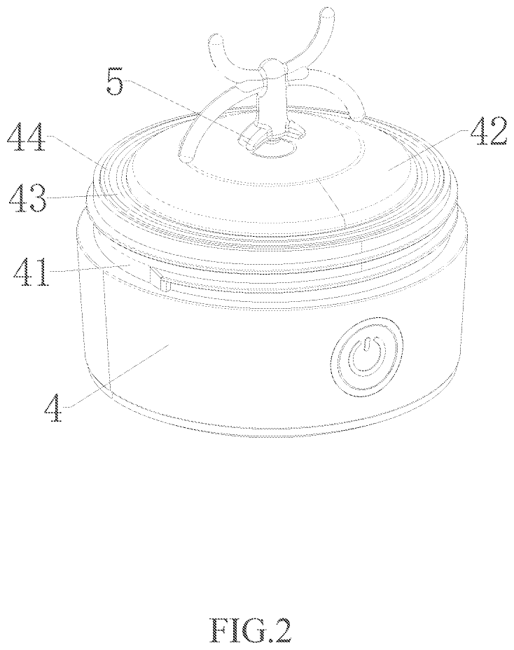

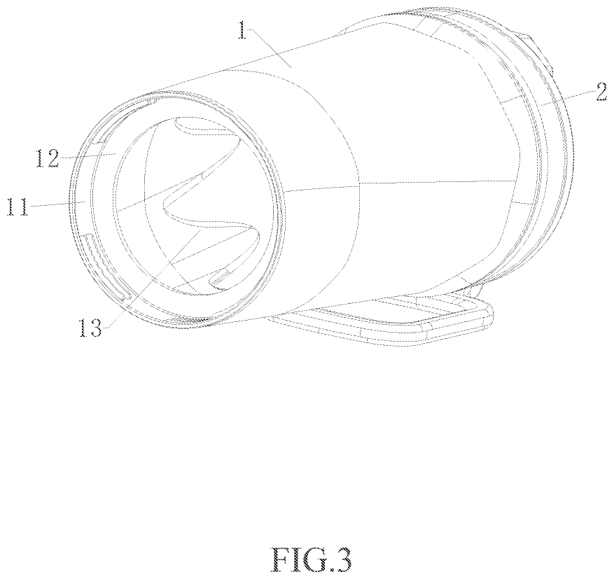

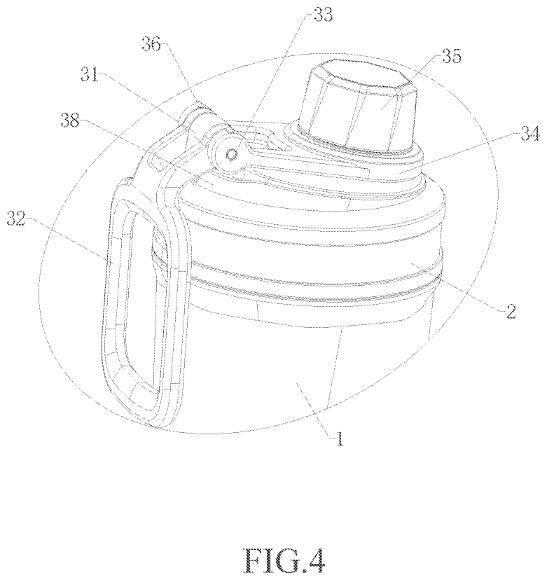

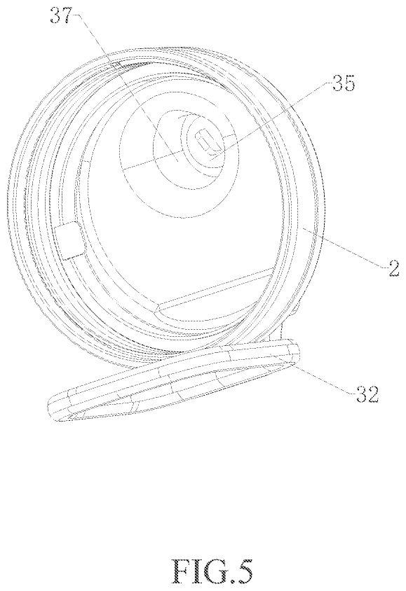

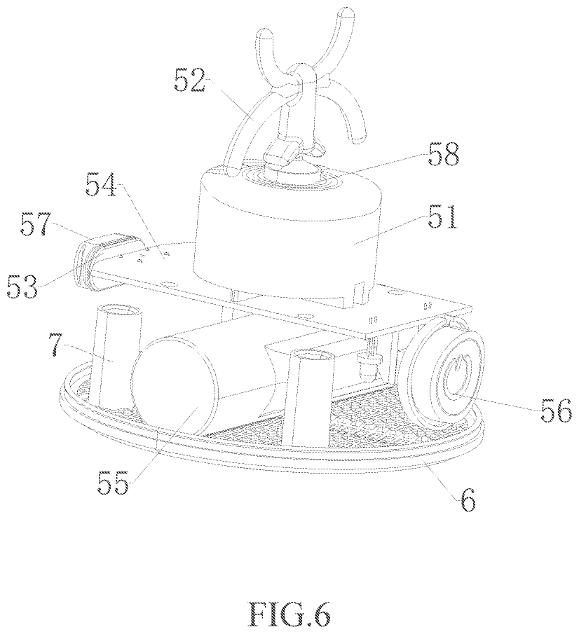

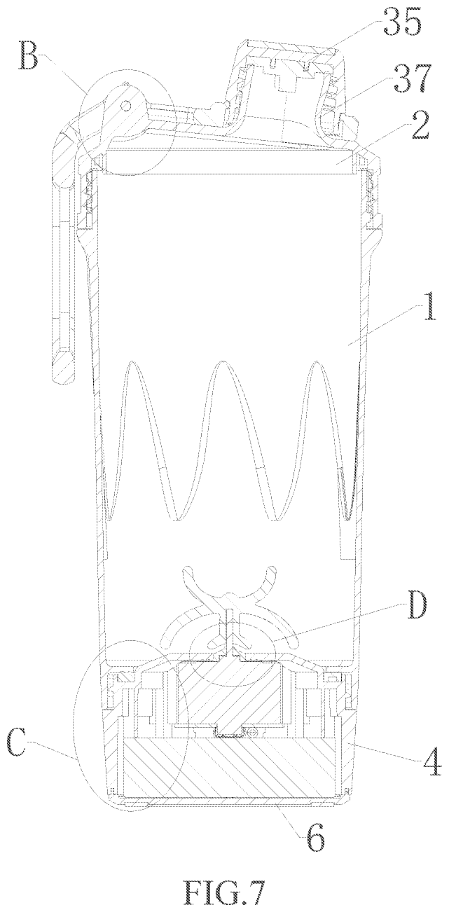

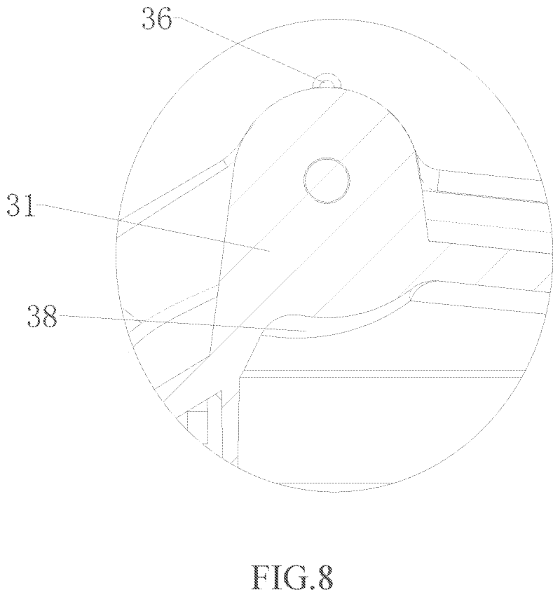

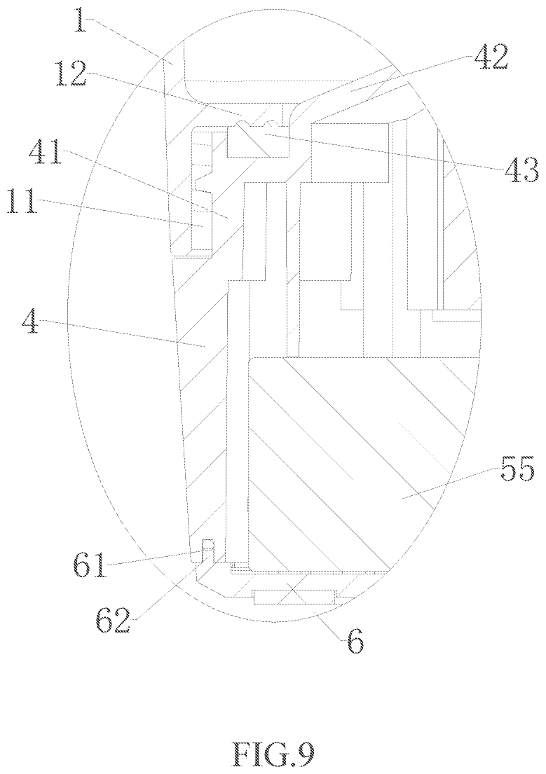

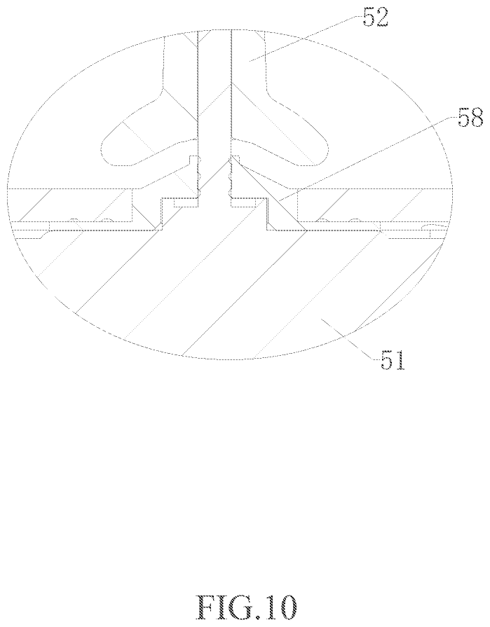

Embodiments: as shown in FIGS. 1-10, the present invention provides an electric stirring cup, including a hollow cup body 1, where one end of the hollow cup body 1 is connected with a cup cover 2 through threaded connection; one end of the hollow cup body 1 far from the cup cover 2 is connected with a base 4; a connecting end 41 is integrally formed on the base 4; an inner wall of the one end of the hollow cup body 1 far from the cup cover 2 forms a connecting cavity 11; the connecting cavity 11 is in threaded connection with the connecting end 41; a stirring mechanism 5 is installed in the base 4; and a drinking mechanism 3 is installed on the cup cover 2.

According to the above technical solution, the hollow cup body 1 and the base 4 are connected with the connecting end 41 through the connecting cavity 11, and during usage, the base 4 is located at the bottom of the hollow cup body 1; the cup cover 2 is unscrewed, the drink to be stirred is poured into the hollow cup body 1, and directly stirred and mixed through the stirring mechanism 5; after mixing, the drink can be directly drunk through the drinking mechanism 3, without the need to unscrew the cup for drinking, which is convenient for using. In addition, the inner cavity of the hollow cup body 1 and the stirring mechanism 5 can be directly cleaned after the base 4 is disassembled, which is convenient for cleaning.

Furthermore, both the hollow cup body 1 and the base 4 are of a round table structure with large upper part and small lower part; an end face of one end of the connecting end 41 far from the base 4 is integrally formed with a convex block 42; a circular edge of the convex block 42 is embedded with a sealing gasket 43; an inner wall of the connecting cavity 11 is fixedly installed with a pressing ring 12; the pressing ring 12 is tightly pressed on the sealing gasket 43; an inner wall of one end of the hollow cup body 1 close to the connecting cavity 11 is integrally formed with a plurality of flow blocking protrusions 13; the convex block 42 is of an upward convex spherical structure; the diameter of one end of the convex block 42 close to the sealing gasket 43 is smaller than the inner diameter of the pressing ring 12; the sealing gasket 43 is of an annular structure, and the top of the sealing gasket 43 is integrally formed with a plurality of annular protrusions 44 with semicircular cross sections, to block water flow; the bottom of the pressing ring 12 is tightly pressed on the annular protrusions, and the stirring mechanism 5 penetrates the convex block 42 and extends into an inner cavity of the hollow cup body 1.

According to the above technical solution, when the hollow cup body 1 and the base 4 are connected to the connecting end 41 by the connecting cavity 11 through thread connection; the convex block 42 protrudes from the inner cavity of the pressing ring 12, and the pressing ring 12 is tightly pressed on the sealing gasket 43 to achieve sealing, so as to avoid the leakage of the drink. In addition, the inner cavity of the sealing gasket 43 is hollow, so that the pressing ring 12 can squeeze the sealing gasket 43 for pressing and sealing. During stirring, the flow blocking protrusion 13 causes an uneven structure in the inner wall of the hollow cup body 1, so as to avoid the vortex in the drink when it is stirred continuously, thereby making the mixing more evenly.

Further, the drinking mechanism 3 includes a hinged fixed base 31 and a drinking nozzle 37, one end of the top of the cup cover 2 is fixedly installed with the hinged fixed base 31, the other end of the top of the cup cover 2 is integrally formed with the drinking nozzle 37, the hinged fixed base 31 is rotatably installed with a lifting ring 32 and a rotating block 33 through a hinge pin; the lifting ring 32 is capable of being turned upward with respect to the rotating block 33, an outer wall of the rotating block 33 is fixedly connected with a connecting ring 34, the connecting ring 34 is internally rotated and clamped with a sealing cover 35, the sealing cover 35 is connected with the drinking nozzle 37 through threaded connection, the top of the cup cover 2 is integrally formed with a stop surface 38, an outer wall of the rotating block 33 is installed with a stop block 36, the stop block 36 is of an elastic plastic hemisphere structure, and the stop surface 38 is of an arc structure.

With the above technical solution, the sealing cover 35 is connected with the drinking nozzle 37 to seal. At this time, it is convenient to carry the cup through lifting the lifting ring 32. During drinking, the sealing cover 35 is unscrewed, and the connecting ring 34 rotates through the rotating block 33, so that the drinking nozzle 37 is exposed, which is convenient for drinking directly through the drinking nozzle 37. Besides, when the rotating block 33 rotates, the stop block 36 moves along the stop surface 38 of the arc structure, and the distance between the stop surface 38 and the rotating block 33 gradually decreases, so as to squeeze the stop block 36 for damping and fixing, and prevent the sealing cover 35 from falling on a user's face during drinking.

Further, one end of the base 4 far from the hollow cup body 1 is provided with a bottom cover 6; an edge of the bottom cover 6 is integrally formed with a snap ring 62; a bottom surface of the base 4 is provided with a snap groove 61; the snap ring 62 is clamped to the snap groove 61; and a sealing circle is arranged between the top of the snap ring 62 and an inner wall of the snap groove 61; a plurality of connecting columns 7 are fixedly installed on the bottom cover 6; the connecting column 7 and an inner wall of the base 4 are connected through a bolt; a motor 51 is comprised in the stirring mechanism 5; the motor 51 is arranged inside the base 4; an output shaft of the motor 51 penetrates the convex block 42 and fixedly clamps a stirring blade 52; the center of the top of the convex block 42 is fixedly sleeved with a sealing ring 58; and the output shaft of the motor 51 penetrates the sealing ring 58.

Through the above technical scheme, the bottom cover 6 is clamped with the snap groove 61 through the snap ring 62; the bottom of the connecting column 7 is connected with the inner wall of the base 4 through a countersunk bolt, so that after the thread is tightened, the sealing circle between the snap ring 62 and the snap groove 61 is pressed and sealed to improve the waterproof performance. The stirring blade 52 is located in the hollow cup 1, and the drink in the hollow cup 1 are stirred and mixed by the rotation of the motor 51, and the output shaft of the motor 51 and the convex block 42 are sealed by the sealing ring 58, which improves water resistance.

Further, a circuit board 54 is fixedly installed in the base 4; the motor 51 is fixedly installed on the circuit board 54; both sides of the base 4 are respectively installed with a switch button 56 and a charging port 53; the charging port 53 is movably clamped with a silicone plug 57; the top of the bottom cover 6 is fixedly installed with a storage battery 55; the motor 51, the storage battery 55, the switch button 56 and the charging port 53 are all electrically connected to the circuit board 54.

Through the above technical solution, the storage battery 55 provides energy and controls the start and stop of the motor 51 through the switch button 56. The charging port 53 is used to charge the storage battery 55. The circuit board 54 is a commonly used battery charging and discharging circuit. The silicone plug 57 is usually clamped to the charging port 53 for dust prevention and is pulled out during charging.

Working principle: the hollow cup body 1 and the base 4 are connected through the connecting cavity 11 and the connecting end 41. The convex block 42 protrudes from the inner cavity of the pressing ring 12, and the pressing ring 12 is tightly pressed on the sealing gasket 43 to achieve sealing, so as to avoid the leakage of a drink. During stirring, the stirring blade 52 is located in the hollow cup body 1, and the drink in the hollow cup body 1 is stirred and mixed by the rotation of the motor 51. The flow blocking protrusion 13 makes the inner wall of the hollow cup body 1 produce an uneven structure, thereby preventing the eddy current of the drink when the drink is rotated and stirred continuously, so that the mixing is more uniform. After stirring, the sealing cover 35 is unscrewed, and the connecting ring 34 rotates through the rotating block 33, so that the drinking nozzle 37 is exposed, which is convenient for drinking directly through the drinking nozzle 37. Besides, when the rotating block 33 rotates, the stop block 36 moves along the stop surface 38 of the arc structure, and the distance between the stop surface 38 and the rotating block 33 gradually decreases, so as to squeeze the stop block 36 for damping and fixing, and prevent the sealing cover 35 from falling on a user's face during drinking. The inner cavity of the hollow cup body 1 and the stirring blade 52 can be directly cleaned after the base 4 is disassembled, which is convenient for cleaning.

Apparently, those skilled in the art can make various modifications and variations of the present invention without departing from the spirit and scope of the present invention. In this way, if these modifications and variations of the present invention fall within the scope of the claims of the invention and their equivalents, the invention present is also intended to include these modifications and variations.

The above contents are only preferred embodiments of the present invention and are not intended to limit the present invention. For those skilled in the art, the present invention can have various changes and variations. Any modifications, equivalent replacements, improvements and the like made within the spirit and principle of the present invention shall be included in the protection scope of the present invention.

1. An electric stirring cup, comprising a hollow cup body, wherein: one end of the hollow cup body is connected with a cup cover through threaded connection; one end of the hollow cup body far from the cup cover is connected with a base; a connecting end is integrally formed on the base; an inner wall of the one end of the hollow cup body far from the cup cover forms a connecting cavity; the connecting cavity is in threaded connection with the connecting end; an end surface of one end of the connecting end far from the base is integrally formed with a convex block; a circular edge of the convex block is embedded with a sealing gasket; an inner wall of the connecting cavity is installed with a pressing ring; the pressing ring is tightly pressed on the sealing gasket; a stirring mechanism is installed in the base; and a drinking mechanism is installed on the cup cover.

2. The electric stirring cup according to claim 1, wherein: the hollow cup body and the base are of a round table structure with a large upper part and a small lower part, and an inner wall of one end of the hollow cup body close to the connecting cavity is provided with a number of flow blocking protrusions.

3. The electric stirring cup according to claim 1, wherein: the convex block is of an upward convex spherical structure; the diameter of one end of the convex block close to the sealing gasket is smaller than the inner diameter of the pressing ring; the sealing gasket is of an annular structure; the top of the sealing gasket is integrally formed with a plurality of annular protrusions with semicircular cross section; the bottom of the pressing ring is tightly pressed on the annular protrusions; and the stirring mechanism penetrates the convex block and extends into an inner cavity of the hollow cup body.

4. The electric stirring cup according to claim 1, wherein: the drinking mechanism comprises a hinged fixed base and a drinking nozzle; one end of the top of the cup cover is fixedly installed with the hinged fixed base; the other end of the top of the cup cover is integrally formed with the drinking nozzle; the hinged fixed base is rotatably installed with a lifting ring and a rotating block through a hinge pin; the lifting ring is capable of being turned upward with respect to the rotating block; an outer wall of the rotating block is fixedly connected with a connecting ring; the connecting ring is internally rotated and clamped with a sealing cover; and the sealing cover is connected with the drinking nozzle through threaded connection.

5. The electric stirring cup according to claim 4, wherein: the top of the cup cover is integrally formed with a stop surface; an outer wall of the rotating block is installed with a stop block; and the stop block is of an elastic plastic hemisphere structure, and the stop surface is of an arc structure.

6. The electric stirring cup according to claim 2, wherein: one end of the base far from the hollow cup body is provided with a bottom cover; an edge of the bottom cover is integrally formed with a snap ring; a bottom surface of the base is provided with a snap groove; the snap ring is clamped to the snap groove; and a sealing circle is arranged between the top of the snap ring and an inner wall of the snap groove; a plurality of connecting columns are fixedly installed on the bottom cover; the connecting column and an inner wall of the base are connected through a bolt; a motor is comprised in the stirring mechanism; the motor is arranged inside the base; an output shaft of the motor penetrates the convex block and fixedly clamps a stirring blade; the center of the top of the convex block is fixedly sleeved with a sealing ring, and the output shaft of the motor penetrates the sealing ring.

7. The electric stirring cup according to claim 6, wherein: a circuit board is fixedly installed in the base; the motor is fixedly installed on the circuit board; both sides of the base are respectively installed with a switch button and a charging port; the charging port is movably clamped with a silicone plug; the top of the bottom cover is fixedly installed with a storage battery; the motor, the storage battery, the switch button and the charging port are all electrically connected to the circuit board.
